(19) United States
(12) Patent Application Publication
(10) Pub. No.: US 2014/0313221 A1
(43) Pub. Date: Oct. 23, 2014

(54) IMAGING MAIL

(71) Applicant: OUTBOX, INC., Austin, TX (US)

(72) Inventors: Jason Gregory SERIFF, Austin, TX (US); William Jewell DAVIS, JR., Austin, TX (US)

(73) Assignee: OUTBOX, INC., Austin, TX (US)

(21) Appl. No.: 13/868,380

(22) Filed: Apr. 23, 2013

(51) Int. Cl. G06T 7/00

(52) U.S. Cl. CPC G06T 7/0081
USPC 345/620

(57) ABSTRACT

Embodiments of the present invention generally relate to turning snail mail into electronic mail. A digital image of the snail mail is captured using a digital camera, and an index number is applied to the digital image. The digital image is processed to remove any visible background from the digital image, and the digital image is rotated to orient the digital image in a desired orientation. The digital image may then be scanned to determine if the digital image contains a barcode. The digital image is then uploaded to a server and is accessible to an intended recipient of the snail mail.

### BACKGROUND OF THE INVENTION

1. Field of the Invention

Embodiments of the present invention generally relate to converting paper-based mail typically received from a postal carrier (i.e., snail mail) into electronic mail.

2. Description of the Related Art

It is a digital world, yet most people are still tethered to their mailbox to receive bills and other paper-based communications. Many households have access to the internet and are moving to paperless bill-pay whereby the bill is never printed in paper form, but rather, is delivered electronically to the intended recipient. Not all businesses are sophisticated enough to have electronic delivery of bills and thus rely upon paper-based communication. Therefore, to date, some bills (and incidentally, the rest of the paper-based mail) are delivered by the postal carrier and complete elimination of snail mail has not happened.

Additionally, when people travel, oftentimes they will have someone pick up their snail mail for them. Alternatively, rather than have someone pick up their snail mail, people will make a special trip to their local Post Office and complete paperwork to have the United States Postal Service (USPS) stop delivery of snail mail for a specified period of time. Of course, during the time on travel, the snail mail is at home (or at the Post Office) and not accessible.

Thus, there is a need in the art for a more convenient manner of receiving snail mail delivered by the USPS.

### SUMMARY OF THE INVENTION

Embodiments of the present invention generally relate to turning snail mail into electronic mail. A digital image of the snail mail is captured using a digital camera, and an index number is applied to the digital image. The digital image is processed to remove any visible background from the digital image, and the digital image is rotated to orient the digital image in a desired orientation. The digital image may then be scanned to determine if the digital image contains a barcode. The digital image is then uploaded to a server and is accessible to an intended recipient of the snail mail.

In one embodiment, a method of converting paper-based mail to electronic mail comprises receiving a digital image of the paper-based mail, determining a resolution of the digital image, and compiling a vote map from the digital image. The method further comprises removing at least a portion of a background from the digital image, rotating the digital image, cropping the digital image, and uploading the digital image to server.

In another embodiment, a non-transitory computer-readable medium is provided. The non-transitory computer-readable medium contains instructions, that, when executed by a processor of a computing system, causes the system to perform the operations of receiving a digital image of the paper-based mail, determining a resolution of the digital image, compiling a vote map from the digital image, removing at least a portion of a background from the digital image, rotating the digital image, cropping the digital image, and uploading the digital image to server.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example of a system according to one embodiment of the invention.

FIG. 2 is a flow diagram illustrating operations for imaging mail according to one embodiment of the invention.

FIGS. 3A-3D illustrate processing of digital images according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to turning snail mail into electronic mail. A digital image of the snail mail is captured using a digital camera, and an index number is applied to the digital image. The digital image is processed to remove any visible background from the digital image, and the digital image is rotated to orient the digital image in a desired orientation. The digital image may then be scanned to determine if the digital image contains a barcode. The digital image is then uploaded to a server and is accessible to an intended recipient of the snail mail.

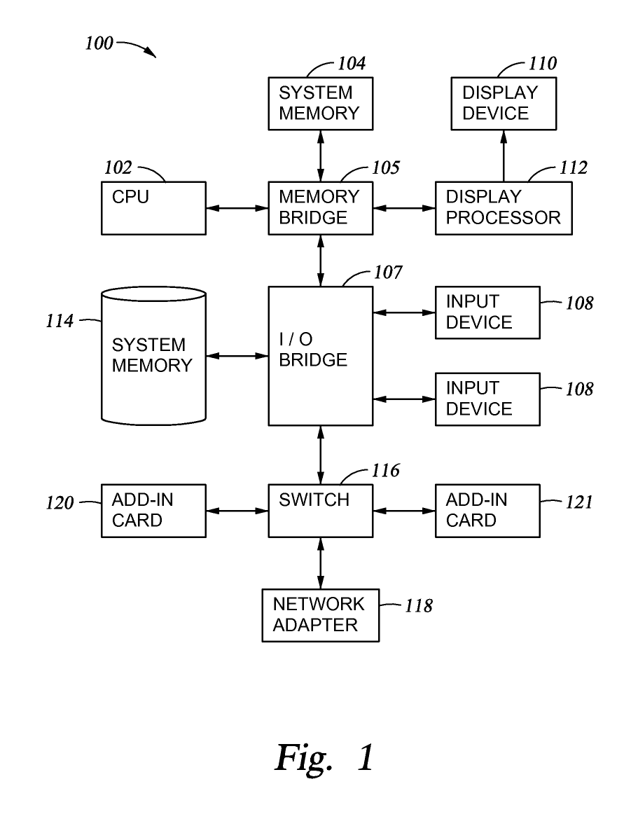

FIG. 1 is a schematic illustration of a system 100 configured to implement one or more aspects of the invention. As shown, system 100 includes a central processing unit (CPU) 102 and a system memory 104 communicating via a bus path that may include a memory bridge 105. The CPU 102 includes one or more processing cores, and, in operation, the CPU 102 is the master processor of the system 100, controlling and coordinating operations of other system components. The system memory 104 stores software applications and data for use by the CPU 102. The CPU 102 runs software applications and optionally an operating system. The memory bridge 105, which may be, e.g., a Northbridge chip, is connected via a bus or other communication path (e.g., a HyperTransport link) to an I/O (input/output) bridge 107. The I/O bridge 107, which may be, e.g., a Southbridge chip, receives user input from one or more user input devices 108 (e.g., a mouse, a keyboard, or a camera) and forwards the input to CPU 102 via memory bridge 105.

An optional display processor 112 is coupled to memory bridge 105 via a bus or other communication path (e.g., a PCI Express, Accelerated Graphics Port, or HyperTransport link). In one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within the system memory 104.

The display processor 112 periodically delivers pixels to an optional display device 110 (e.g., a screen or conventional CRT, plasma, LED, OLED, SED or LCD based monitor or television). Additionally, the display processor 112 may output pixels to film recorders adapted to reproduce computer generated images on photographic film. The display processor 112 can provide the display device 110 with an analog or digital signal.

A system disk 114 is also connected to the I/O bridge 107 and may be configured to store content and applications and data for use by the CPU 102 and the display processor 112. The system disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O the bridge 107 and other components such as a network adapter 118 and various optional add-in cards 120 and 121. The network adapter 118 allows the system 100 to communicate with other systems via an electronic communications network, and may include wired or wireless communication over local area networks and wide area networks such as the Internet.

Other components (not shown), including USB or other port connections may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, the display processor 112 incorporates circuitry optimized for graphics and video processing, including, for example, video output circuitry, and constitutes a graphics processing unit (GPU). In another embodiment, the display processor 112 incorporates circuitry optimized for general purpose processing. In yet another embodiment, the display processor 112 may be integrated with one or more other system elements, such as the memory bridge 105, the CPU 102, and the I/O bridge 107 to form a system on chip (SoC). In still further embodiments, the display processor 112 is omitted and software executed by the CPU 102 performs the functions of the display processor 112.

Pixel data can be provided to the display processor 112 directly from the CPU 102. In some embodiments of the present invention, instructions and/or data representing a scene are provided to a render farm or a set of server computers, each similar to the system 100, via the network adapter 118 or the system disk 114. The render farm generates one or more rendered images of the scene using the provided instructions and/or data. These rendered images may be stored on computer-readable media in a digital format and optionally returned to the system 100 for display. Similarly, stereo image pairs processed by the display processor 112 may be output to other systems for display, stored in the system disk 114, or stored on computer-readable media in a digital format.

Alternatively, CPU 102 provides the display processor 112 with data and/or instructions defining the desired output images, from which the display processor 112 generates the pixel data of one or more output images, including characterizing and/or adjusting the offset between stereo image pairs. The data and/or instructions defining the desired output images can be stored in the system memory 104 or graphics memory within the display processor 112. In an embodiment, the display processor 112 includes 3D rendering capabilities for generating pixel data for output images from instructions and data defining the geometry, lighting shading, texturing, motion, and/or camera parameters for a scene. The display processor 112 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, the system memory 104 is connected to the CPU 102 directly rather than through a bridge, and other devices communicate with the system memory 104 via the memory bridge 105 and the CPU 102. In other alternative topologies the display processor 112 is connected to the I/O bridge 107 or directly to the CPU 102, rather than to the memory bridge 105. In still other embodiments, the I/O bridge 107 and the memory bridge 105 might be integrated into a single chip. The particular components shown herein are optional; for instance, any number of add-in cards or peripheral devices might be supported. In some embodiments, the switch 116 is eliminated, and the network adapter 118 and the add-in cards 120, 121 connect directly to the I/O bridge 107.

As discussed above, embodiments described herein generally relate to converting paper-based mail into electronic mail. The paper-based mail is delivered to an intended recipient's mailbox and then retrieved (i.e., intercepted by a third party) before the intended recipient collects the paper-based mail from the mailbox. The retrieved mail is then converted into an electronic file (e.g., imaged) and is stored on a server. The intended recipient of the paper-based mail may then access the electronic file to view the snail mail in electronic format.

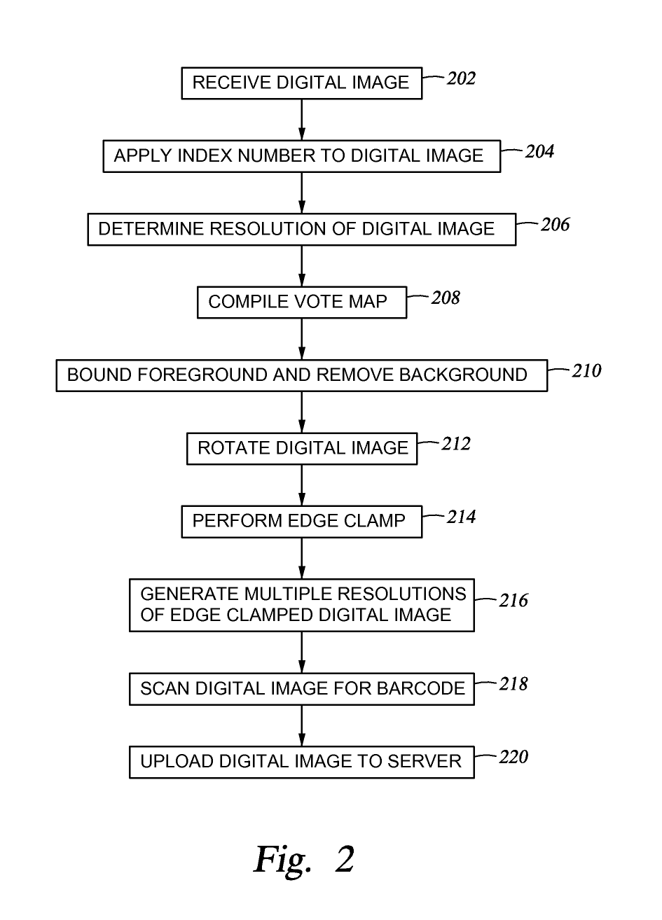

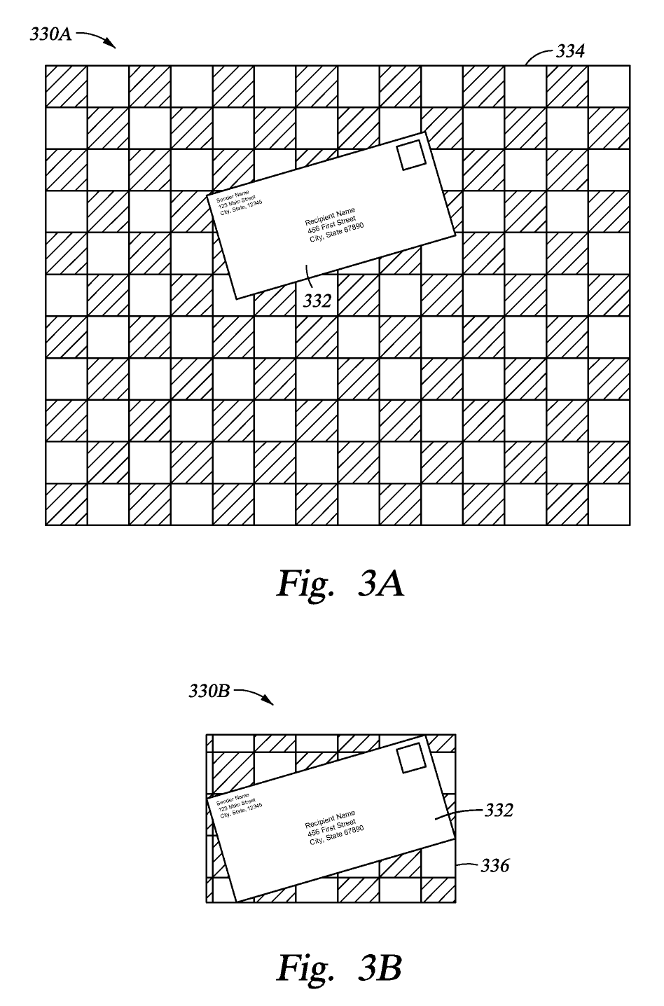

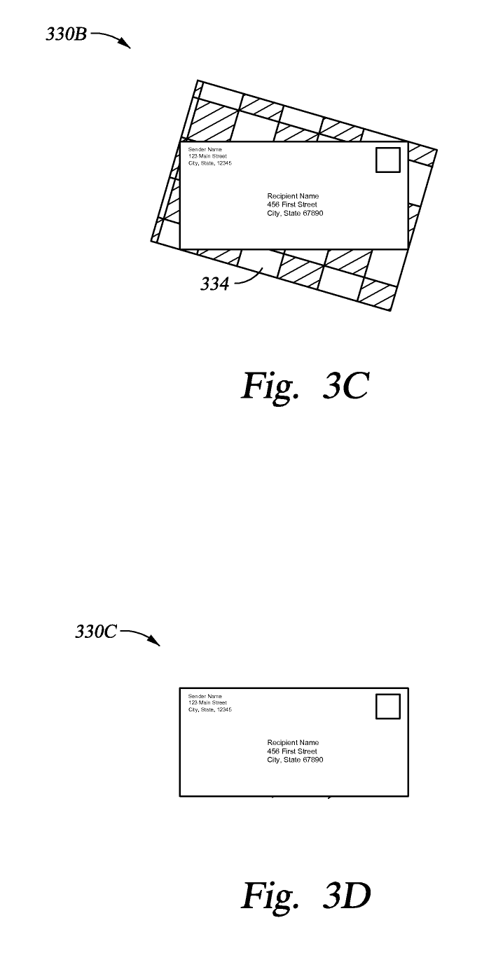

FIG. 2 is a flow diagram 200 illustrating operations for imaging mail according to one embodiment of the invention. Flow diagram 200 is explained in conjunction with FIGS. 3A-3D, which illustrate a digital image during processing. Flow diagram 200 begins at operation 202 in which a digital image is received by a software application. The digital image is captured using a digital camera and a predetermined background upon which a desired piece of paper-based is positioned during image capturing.

FIG. 3A illustrates a digital image 330A of paper-based mail 332 (e.g., an envelope) captured against a background 334. The background 334 includes a pattern of predetermined size and color. In one example, the predetermined pattern includes quarter-inch squares of alternating red and green color. The pattern is selected so that the background 334 can be easily distinguished from the paper-based mail 332 during image processing. Additionally, the size of the squares in the pattern is selected to facilitate the determination of image resolution, as explained further with respect to operation 206. It is contemplated that other patterns having different sizes, shapes, and colors may be utilized.

In operation 204, the software application applies an index number to the digital image 330A. The index number facilitates cataloging of the digital image 330A, as well as correlation of the digital image 330A to the original piece of paper-based mail. In operation 206, the software application determines the resolution of the digital image 330A. Because the background 334 includes a pattern of known dimensions, the software application can utilize the dimensions to calculate dots-per-inch of the digital image 330A, regardless of camera position or level of zoom of the camera. In one example, during operation 206, the software application scans a predetermined number of lines of pixels (for example, five lines) along each side of the image. The five lines of each side may be positioned within the first 50 pixels to ensure that background, rather than foreground, is scanned. During operation 206, the software application measures the distance between pixel color changes, and determines the median distance (in pixels) between color changes for all of the scanned lines (for example, 20 lines). Because the physical distance between color changes is a known value of the background pattern, the software application can determine the dots-per-inch of the digital image 330A.

In operation 208, the software application compiles a vote map. The vote map is utilized to distinguish the background 334 from the foreground (e.g., the paper-based mail 332). In operation 208, the software application scans each line of pixels in the digital image 330A. The digital image 330A is scanned in four directions. Based on pixel color and color run length (e.g., the number of consecutive pixels of the same color), each pixel may receive a vote for each scan direction. For example, if the pixel color and color run length are consistent with the known characteristics of the background, a particular pixel receives a vote. Each pixel may receive up to four votes (one for each direction of scan). Because the pixel color and color run length of the background 334 are known, the software application can distinguish background from foreground. Thus, it is desirable to utilize a background 334 that will not likely have the same pattern or appearance as a foreground object. After compiling the vote map, any pixel that receives at least two votes will be considered “likely background” by the software application.

In operation 210, the background 334 is removed from the digital image 330A. The software application scans the vote map searching for lines of continuous foreground (e.g., pixels having zero or one vote). Adjacent foreground pixels are grouped into regions, and then adjacent and near-adjacent regions of foreground pixels are collapsed together. Optionally, any regions having a predetermined size, such as an area less than about 1 square inch, may not be included in collapsing. In this manner, small areas of background inadvertently marked as foreground would be excluded from the collapsing. Subsequently, in operation 210, the single largest collapsed region of foreground is bounded by a rectangle, e.g., a bounding box 336, as shown in FIG. 3B. In the event the paper-based mail 332 is oriented at an angle during capturing of the digital image 330A, some background 334 may be included in the rectangle 336. The included background 334 will be removed from the within the rectangle in subsequent operations, as described below.

In operation 212, each edge of the digital image 330B is scanned to determine the slope of the paper-based mail 332 within the digital image 330B, relative to the rectangle 336. The scanning determines the transition point of each line of pixels as the digital image 330B transitions from the known background 334 to the image of the paper-based mail 332. Utilizing the transition point for each line of pixels along a side of the paper-based mail 332, the approximate edge of the paper-based mail 332 is determined. This process is performed on all four sides of the digital image 330B. The software application then determines the average relative angle between a side of the rectangle 332 and a relative side of the paper-based mail 332 within the digital image 330B. The software application then counter rotates the digital image 330B a number of degrees equal to the average relative angle, such that the image of the paper-based mail 332 is in a desired orientation, as shown in FIG. 3C. Because the software application is capable of orienting the paper-based mail 332 in a desired orientation, the paper-based mail 332 does not need to be perfectly oriented when the digital image 330A is originally captured. Thus, a user does not need to spend time properly orienting the paper-based mail for image capturing, and paper-based mail can be converted to electronic mail more quickly.

In operation 214, an edge clamp (e.g., crop) is performed to remove the remainder of the visible background. Utilizing the edge determinations from operation 212, any remaining visible background 334 can be removed by cropping the digital image 330B, thus resulting in digital image 330C. Optionally, the digital image 330B may be over-cropped, for example, about one-eighth inch beyond each edge of the image of the paper-based mail 332, thus ensuring that none of the background 334 is visible in the digital image 330C. It is contemplated that the over-cropping distance can be adjusted as desired and may, for example, be based on a predetermined number of pixels.

After performing the edge clamp in operation 214, multiple resolutions of the digital image 330C are generated by the software application in operation 216. Thus, multiple resolutions of the digital image 330C are available for use depending on the desired display qualities of the digital image 330C. For example, a lower resolution version of digital image 330C may be utilized for display as a thumbnail, while higher resolution versions may be utilized as necessary for displaying more-detailed images. It is contemplated that the software application, or another application, may select which version or resolution to display according to the use of the image.

In operation 218, the software application scans the digital image 330C to determine the presence of a PostNet barcode. The digital image 330C may be scanned line-by-line to determine the presence of a barcode. The digital image may be rotated to enhance the detection of barcodes. For example, the digital image may be scanned in a first position, and then rotated one degree, and scanned again. In this manner, it is contemplated that the digital image 330C may be rotated one or more degrees in any direction and scanned for the detection of barcodes. In one example, the digital image 330C may be scanned up to 20 times in 20 different orientations. Once a barcode is detected, the software application determines the physical address encoded by the bar code. Thus, as user does not need to manually associate digital image 330C with a physical address because the physical address is detected by the software application.

In operation 220, the digital image 330C (and any lower resolution versions) are uploaded to a server. The digital images are accessible by a user associated with an account. The account is associated with the physical address of paper-based mail. Thus, the digital image 330C is associated with an account by the software application using the detected bar code.

Operations 202-220 can be repeated for multiple pieces of paper-based mail. In one example, the multiple pieces of paper-based mail may be packaged as a single letter. In such an example, a digital image may be captured for each of the front and back of the envelope, as well as the front and back of each piece of content contained therein. A marker, such as a colored marker, may be utilized to separate individual letters. Thus, as the software application processes received digital images, the software application can group multiple digital images together using the colored markers as beginning and end points of distinct packages of paper-based mail.

In one example, a digital image of a colored marker may be captured by the digital camera. The contents of a paper-based letter, and the envelope, if desired, may then subsequently be captured using the digital camera. After capturing all desired digital images of the paper-based mail, a digital image of the marker may be captured again, thus indicating to the software application that the prior digital images (e.g., all images captured between the markers) are from a single package of paper-based mail. The second digital image of the marker indicates to the software application that the preceding digital images belong to a first package of paper-based mail, and the subsequent digital images belong to a second package of paper-based mail. The software application can then group digital images from the same package of paper-based mail.

In addition, it is contemplated that markers of different colors may be used to distinguish between different classes of mail. For example, a first color may be used to indicate that the subsequent digital images are of a first mail class type (e.g., first class mail), while a second color may indicate that subsequent digital images are of a second mail class type (e.g., standard mail). Because the software application can distinguish between diverse classes of mail using the different colored markers, it is contemplated that the software application may treat the different classes of mail differently. For example, the software application may place the different classes of mail in different folders when uploading the digital images to the server in operation 220. Thus, under each user account, folders may exist for different classes of mail.

Flow diagram 200 illustrates one embodiment; however, other embodiments are also contemplated. In one embodiment, operation 218 may occur subsequent to operation 220. In such an embodiment, bar code scanning is performed on the server. In another embodiment, it is contemplated that paper-based mail of different classes may be treated differently for purposes of converting paper-based mail to electronic mail. For example, for first class mail, it is contemplated that the front and back of the envelope, as well as the front and back of all contents therein, may be digitally captured. However, for standard class mail, it is contemplated that only the front and back of the envelope may be digitally captured. Thus, for standard class mail, less than the entire paper-based mail item is digitally captured, in one embodiment.

In another embodiment, it is contemplated that the software application can recognize redundant pieces for mail directed to the same or multiple recipients. For example, if a retailer distributes a piece of standard class paper-based mail to multiple recipients, the software application can recognize that multiple users are receiving an identical article of mail. In such a case, the software application may upload only a single electronic copy to the server in operation 220; however, multiple user accounts would have access to the same electronic copy. In this regard, substantial server memory space is saved. In yet another embodiment, either or both of operations 204 and 214 may be optional.

In yet another embodiment, it is contemplated that any of operations 202-218 may be performed on or by a server or other remote computing device. It is also contemplated that operations 202-218 may be performed by any combination of a local computing device or a remote computing device. For example, some of operations 202-218 may be performed on a local computing device, while the remainder of operations 202-218 may be performed by the remote computing device. Thus, in such an embodiment, it is contemplated that some data may be “pushed” to a server or remote computing device, and processed by the server or remote computing device.

Benefits of the invention include the conversion of paper-based mail to electronic mail. A software application is utilized to convert the paper-based mail to electronic mail. The software is capable of rotating, cropping, grouping, and uploading the electronic mail. Additionally, the software application also facilitates user access to the electronic mail based, in part, on a barcode located on the paper-based mail. Additionally, the software application can distinguish between different classes of mail.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

What is claimed is:

1. A method of converting paper-based mail to electronic mail, comprising:
receiving a digital image of the paper-based mail;
determining a resolution of the digital image;
compiling a vote map from the digital image;
removing at least a portion of a background from the digital image;
rotating the digital image;
cropping the digital image; and
uploading the digital image to a server.

2. The method of claim 1, further comprising applying an index number to the digital image.

3. The method of claim 1, further comprising generating multiple resolutions of the cropped digital image.

4. The method of claim 1, further comprising scanning the digital image for a barcode.

5. The method of claim 4, wherein scanning the digital image for a barcode comprises multiple iterations of rotating the digital image and scanning the digital image.

6. The method of claim 1, wherein compiling a vote map comprises scanning the digital image from four directions.

7. The method of claim 6, further comprising grouping regions of the digital image according to the number of votes received by each pixel.

8. The method of claim 7, wherein the regions include background regions and foreground regions.

9. The method of claim 8, further comprising grouping the foreground regions together.

10. The method of claim 9, further comprising forming a bounding box around the group of foreground regions.

11. The method of claim 10, wherein rotating the digital image comprises determining an angle of slope of the group of foreground regions relative to the bounding box.

12. A non-transitory computer-readable medium containing instructions, that, when executed by a processor of a computing system, causes the system to perform the operations of:
receiving a digital image of the paper-based mail;
determining a resolution of the digital image;
compiling a vote map from the digital image;
removing at least a portion of a background from the digital image;
rotating the digital image;
cropping the digital image; and
uploading the digital image to a server.

13. The non-transitory computer-readable medium of claim 12, further comprising applying an index number to the digital image.

14. The non-transitory computer-readable medium of claim 12, further comprising generating multiple resolutions of the cropped digital image.

15. The non-transitory computer-readable medium of claim 12, further comprising scanning the digital image for a barcode.

16. The non-transitory computer-readable medium of claim 15, wherein scanning the digital image for a barcode comprises multiple iterations of rotating the digital image and scanning the digital image.

17. The non-transitory computer-readable medium of claim 12, wherein compiling a vote map comprises scanning the digital image from four directions.

18. The non-transitory computer-readable medium of claim 12, further comprising grouping regions of the digital image according to the number of votes received by each pixel.

19. The non-transitory computer-readable medium of claim 18, wherein the regions include background regions and foreground regions.

20. The non-transitory computer-readable medium of claim 19, further comprising grouping the foreground regions together.
